(19) United States
(12) Patent Application Publication
(10) Pub. No.: US 2010/0169182 A1
(43) Pub. Date: Jul. 1, 2010

(54) MOBILE PAYMENT METHOD AND SYSTEM USING THE SAME

(76) Inventor: MASIH MADANI, VAN NUYS, CA (US)

Correspondence Address: CHRISTIE, PARKER & HALE, LLP, PO BOX 7068, PASADENA, CA, 91109-7068, US

(21) Appl. No.: 12/346,806

(22) Filed: Dec. 30, 2008

(51) Int. Cl. G06Q 20/00; G06Q 30/00; G06Q 40/00; G10L 21/00

(52) U.S. Cl. 705/21; 705/44; 705/30; 705/40; 704/275

(57) ABSTRACT

A system and method for authenticating a payment transaction. The system includes a transaction association source for providing an association code corresponding to a payment transaction, a transaction terminal in communication with the transaction association source for initiating the payment transaction by requesting and receiving the association code from the transaction association source, and a mobile terminal in communication with the transaction association source for transmitting the association code to the transaction association source. The mobile terminal is configured to receive data of the payment transaction from the transaction association source. The mobile terminal is configured to transmit a response message to the transaction association source to confirm or cancel the payment transaction, and the transaction association source is configured to transmit an approve or cancel message to the transaction terminal in response to receiving the response message.

### BACKGROUND

1. Field of the Invention

The present invention relates to a mobile payment method and a system using the same.

2. Discussion of Related Art

Since the mobile phone was introduced to the general public more than three decades ago, the mobile phone has evolved from a high priced novelty to a widely used communication tool in today's fast paced highly connected society. The mobile phone increasingly serves as the primary means of communication between people and businesses. It allows people to conduct their businesses on the move and in some cases completely replaces the traditional wired telephone system for some users of the mobile phone. Starting as a purely voice communication device, typical mobile phones today often provide significant computing power and data connectivity to the Internet through a digital mobile phone network such as the Global System for Mobile communications (GSM) network or the Code Division Multiple Access (CDMA) network. More advanced versions of digital mobile phone networks such as the CDMA2000 network and the UMTS/HSDPA network are also being deployed to provide faster data connectivity to the mobile phone users. As a result, the mobile phone is no longer a pure voice communication device, but has become a viable mobile computing platform with wireless data connectivity.

As the mobile phone incorporates increasing functionalities, one application that has been gaining interest is using the mobile phone as an electronic wallet to provide a cashless payment solution. Although the widely used credit card also provides a cashless payment solution, it has some shortcomings that can be improved upon or removed. For example, the consumer needs to carry a credit card with him/her, a credit card is not easily available to an applicant with inferior credit history, the risk of credit card fraud has not addressed or removed, and the risk of loss of personal identification information during a credit card payment transaction, etc.

Existing or proposed payment solutions employing the mobile phone appear to require excessive user inputs on the mobile phone, unnecessary complex payment transaction, a data capable mobile phone, and/or disclosure of the consumer's personal information to the merchant in order to complete a transaction. Therefore, it is desirable to provide an improved mobile phone payment solution and method.

### SUMMARY OF THE INVENTION

Accordingly, embodiments of the present invention provide a system and a method for authenticating a payment transaction by a mobile terminal in communication with a transaction association source by a voice network or a data network.

According to an embodiment of the present invention, a system for authenticating a payment transaction includes a transaction association source for providing an association code corresponding to a payment transaction, a transaction terminal in communication with the transaction association source for initiating the payment transaction by requesting the association code from the transaction association source, the transaction terminal configured to receive the association code, and a mobile terminal in communication with the transaction association source for transmitting the association code received by the transaction terminal to the transaction association source, and the mobile terminal for receiving data of the payment transaction from the transaction association source. The mobile terminal is configured to transmit a response message to the transaction association source to confirm or cancel the payment transaction, and the transaction association source is configured to transmit an approve or cancel message to the transaction terminal in response to receiving the response message.

According to another embodiment of the present invention, a method for authenticating a payment transaction includes initiating a payment transaction at a transaction terminal by requesting an association code corresponding to the payment transaction from a transaction association source in communication with the transaction terminal, providing the association code received at the transaction terminal to a user of a mobile terminal, transmitting the association code from the mobile terminal to the transaction association source in communication with the mobile terminal, receiving data of the payment transaction from the transaction association source at the mobile terminal, confirming or denying the payment transaction by transmitting a response message from the mobile terminal to the transaction association source, and transmitting an approve or cancel message from the transaction association source to the transaction terminal in response to receiving the response message by the transaction association source.

The transaction association source may be configured to associate the payment transaction with a user of the mobile terminal.

The transaction association source may be in communication with an account of the user, a bank account of the user, a credit card account of the user, a debit account of the user, or a wireless service provider of the user.

The transaction terminal may include a point-of-sale terminal.

The transaction terminal may be configured to transmit the data of the payment transaction to the transaction association source prior to receiving the association code.

The mobile terminal may be configured to execute a software program to interact with a user of the mobile terminal and to communicate with the transaction association source by a wireless data network, and the software program may be configured to transmit the association code to the transaction association source by the wireless data network.

The software program may be configured to guide the user to input the association code to the mobile terminal, display the data of the payment transaction on a display unit of the mobile terminal, request the user to enter a confirmation input to confirm or deny the payment transaction, and transmit the response message to the transaction association source in response to the confirmation input.

The software program may be configured to authenticate the user of the mobile terminal by requesting the user to enter a passcode or password.

The software program may be configured to transmit a mobile terminal identification to identify the mobile terminal to the transaction association source.

The mobile terminal identification may include a caller ID information, a serial number of the mobile terminal, an IP address of the mobile terminal, a MAC address of the mobile terminal, or an identification number.

The mobile terminal may be configured to establish a voice communication channel to communicate with the transaction association source, and the association code may be transmitted to the transaction association source through the voice communication channel.

The transaction association source may include an interactive voice response (IVR) system for verbal communication with a user of the mobile terminal through the voice communication channel. The IVR system may guide the user to verbally communicate the association code to the IVR system. The IVR system may verbally communicate the data of the payment transaction to the user, and the IVR system may verbally request the user to enter a confirmation input to confirm or deny the payment transaction.

The IVR system may be configured to authenticate the user of the mobile terminal by requesting the user to enter a passcode or password.

The user may enter the passcode or password by an input device of the mobile terminal.

The user may enter the passcode or password by verbally dictating the passcode or password to the mobile terminal.

The association code may have a variable code length. Further, the variable code length may be varied in accordance with a number of payment transactions handled by the transaction association source during a time interval.

### BRIEF DESCRIPTION OF THE DRAWINGS

The accompanying drawings, together with the specification, illustrate exemplary embodiments of the present invention, and, together with the description, serve to explain the principles of the present invention.

FIG. 1a is a drawing illustrating an exemplary system for processing a payment transaction using a mobile terminal according to an embodiment of the present invention.

FIG. 1b is a simplified flow chart of the exemplary system of FIG. 1a for processing a payment transaction using a mobile terminal according to an embodiment of the present invention.

FIG. 2 is a flow chart illustrating a communication process between a customer and a transaction association source using the mobile terminal according to a first embodiment of the present invention.

FIG. 3 is a drawing illustrating a mobile terminal.

FIG. 4 is a flow chart illustrating a communication process between a customer and a transaction association source using the mobile terminal according to a second embodiment of the present invention.

### DETAILED DESCRIPTION OF EXEMPLARY EMBODIMENTS

Hereinafter, certain exemplary embodiments according to the present invention will be described with reference to the accompanying drawings.

According to embodiments of the present invention, a method and a system using the same for processing a financial or commercial transaction (e.g., authenticating a payment transaction) using a mobile terminal are provided. The embodiments of the present invention provide a solution for using the mobile terminal such as a mobile phone or a personal digital assistant (PDA) with voice and/or data connectivity to complete a financial or commercial transaction with improved security, wider service availability and simplicity. It would be appreciated by those skilled in the art that the mobile terminal is not limited to the mobile phone or the PDA, but, on the contrary, the mobile terminal may include any suitable mobile devices that provide voice and/or data communication capabilities. Furthermore, the mobile devices may have software program execution capability according to some embodiments of the present invention.

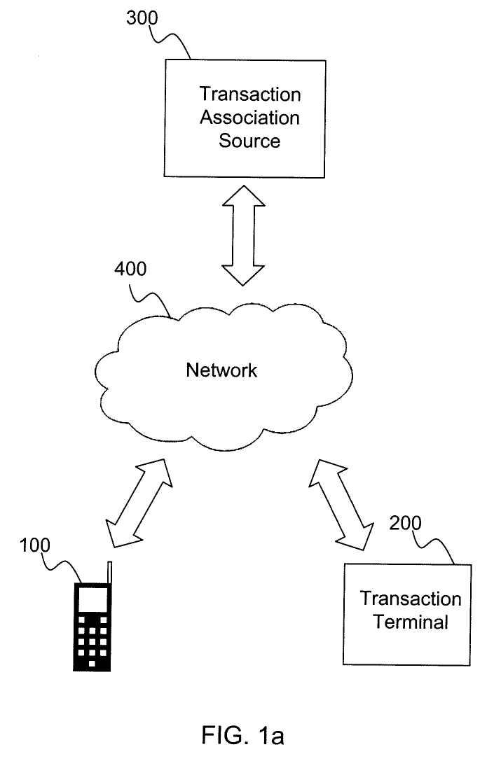

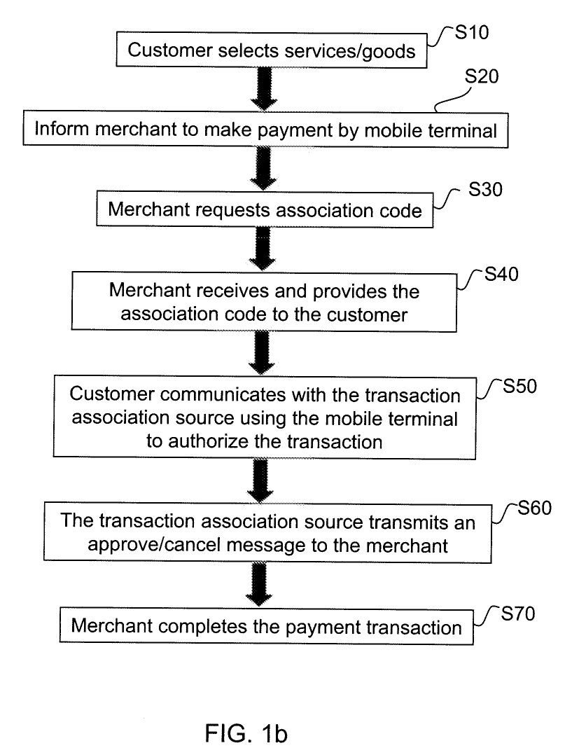

FIG. 1a is a drawing illustrating an exemplary system for processing a payment transaction using a mobile terminal according to an embodiment of the present invention.

In FIG. 1a, an exemplary system for processing a payment transaction includes a mobile terminal 100, a transaction terminal 200 and a transaction association source 300. The mobile terminal 100 and the transaction terminal 200 communicate with the transaction association source 300 through a network 400. The network 400 may be a cellular network, a telephone network, a wireless data network, or other suitable networks that can provide voice and/or data communication between two devices connected through the network 400. In some embodiments of the present invention, the mobile terminal 100 and the transaction terminal 200 communicate with the transaction association source 300 through separate networks. Furthermore, in some embodiments of the present invention, the network 400 may not be a single network, but may include multiple similar or dissimilar networks.

FIG. 1b is a simplified flow chart of the exemplary system of FIG. 1a for processing a payment transaction using a mobile terminal according to an embodiment of the present invention. While FIG. 1b illustrates an exemplary flow chart for processing a payment transaction with a mobile terminal, the present invention is not limited thereto. The principles and operations illustrated in FIGS. 1a and 1b may be applied to other kinds of financial or commercial transactions that are suitable for processing with a mobile terminal.

Referring to FIG. 1b, a customer equipped with a suitable mobile terminal (e.g., a mobile phone, a PDA phone, or a portable computer) selects goods and/or services provided by a merchant to be purchased S10. The customer may be physically located at where the goods and/or services are sold or provided such as the merchant's store. In some embodiments, the customer and the goods and/or services are not located in the same physical location. For example, the customer can make the purchase selection by using the Internet through a website operated by the merchant. After the customer makes the selection, the customer informs the merchant that payment will be made by using the mobile terminal S20. The merchant or its representative (e.g., a cashier) enters the amount of the payment into a transaction terminal such as a point-of-sale terminal (POS) and requests a unique association code from a transaction association source S30, which is in communication (e.g., data communication) with the transaction terminal. The transaction terminal may communicate with the transaction association source through the public switched telephone network (PSTN), the Internet, a wireless data network, or other suitable communication methods.

The code length of the association code may be fixed or variable. In some embodiments of the present invention, the code length of the association code is varied dynamically according to the number of payment transactions handled by the transaction association source S30 at any given time. For example, in some embodiments, when the number of payment transactions increases within a suitable time interval, the code length of the association code increases, and when the number of payment transactions decreases within a suitable time interval, the code length of the association code decreases. It would be appreciated by those skilled in the art that, the code length of the association code determines the maximum number of possible concurrent payment transactions during the suitable time interval. Furthermore, in some embodiments of the present invention, the duration of the suitable time interval is variable.

The transaction association source may be a wireless service provider, a bank, a credit card company, or other suitable entities. In addition to the request for the association code, the transaction terminal may also transfer data regarding the purchase to the transaction association source. For example, the data may include the price, the quantity purchased, the description of the goods/services, etc. After receiving the association code request, the transaction association source provides a unique association code in real time to the merchant. In some embodiments, the association code is retrieved from the transaction terminal. Then, the retrieved association code is provided to the customer S40. Once the customer is provided with the association code, the customer communicates with the transaction association source using the mobile terminal S50.

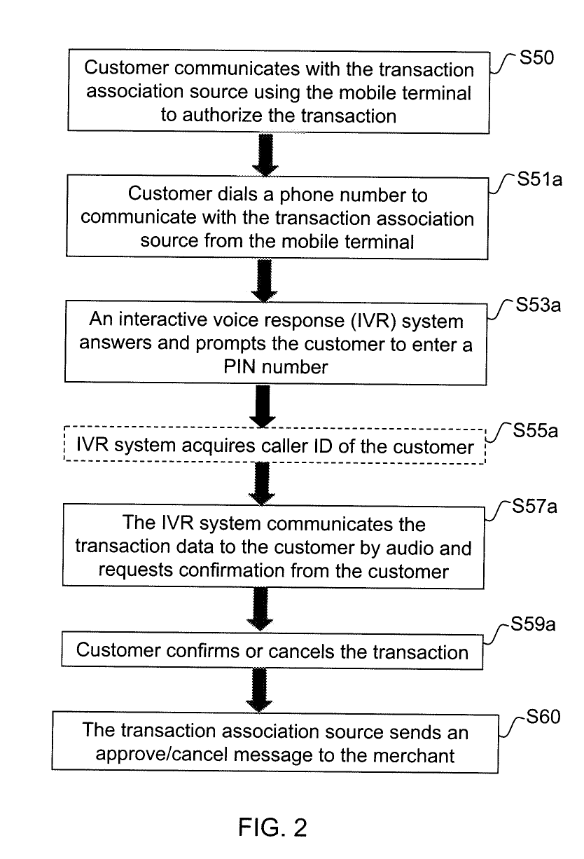

FIG. 2 is a flow chart providing further details on the communications between the customer and the transaction association source using the mobile terminal according to a first embodiment of the present invention. Referring to FIG. 2, the customer dials a telephone number (e.g., a toll free number) associated with the transaction association source to proceed with the payment transaction S51a. An interactive voice response (IVR) system answers and handles the call by prompting the customer to enter a PIN number, followed by the association code S53a. The customer may be pre-assigned with a unique PIN number (e.g., a passcode or a password) that is used to identify and/or authenticate the customer. The PIN number may also be used to associate the customer's account with the transaction association source to the payment transaction. Furthermore, in some embodiments of the present invention, the IVR system may optionally acquire the caller ID information S55a, together with the PIN number, to enhance the security of the payment transaction. Still in some embodiments of the present invention, the caller ID information may replace the PIN number to simplify the transaction, thereby removing the need for the customer to enter the PIN number manually.

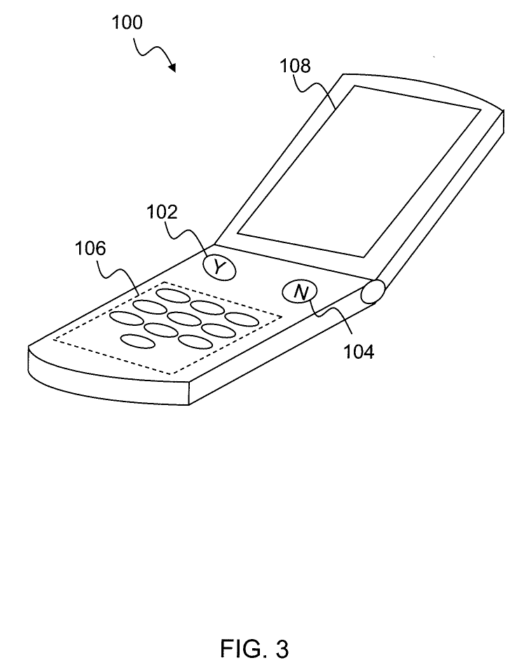

After the IVR system authenticates the customer with the PIN number and/or the caller ID, the IVR system communicates the data (e.g., description of the goods/services purchased and price) of the payment transaction to the customer verbally and requests confirmation from the customer S57a. The customer may confirm or cancel the payment transaction S59a by speaking “YES” or “NO” or by pressing a “YES” button or an “NO” button on the mobile terminal. The “YES” and “NO” buttons may be dedicated keys assigned for confirmation function, or the buttons can be any keys that also serve other functions. For example, the “YES” key may be the “1” key on a keypad of the mobile terminal, and the “NO” key may be the “2” key on the mobile terminal. FIG. 3 illustrates the mobile terminal 100 of FIG. 1a in the form of a mobile phone with dedicated “YES” key 102 and “NO” key 104 in addition to the 0-9 number keys 106. The mobile terminal 100 also has a display 108 for displaying text and/or graphic information. When the customer presses a key of the mobile terminal, the mobile terminal may be configured to generate a corresponding tone such as the dual-tone multi-frequency (DTMF) signaling tone to notify the IVR system about the key pressed.

Once the transaction association source receives a confirm/cancel response from the customer, the transaction association source sends a message (e.g., a code) to the merchant's transaction terminal to complete or cancel the payment transaction S60. If the customer confirms the payment transaction, the transaction association source sends an approve message (e.g., a code) to the merchant's transaction terminal to complete the payment transaction S70. In some embodiments, the transaction terminal may be configured to print out a customer receipt and/or a merchant's copy. If the customer cancels the payment transaction, the transaction association source sends a cancel message to the transaction terminal to terminate the payment transaction.

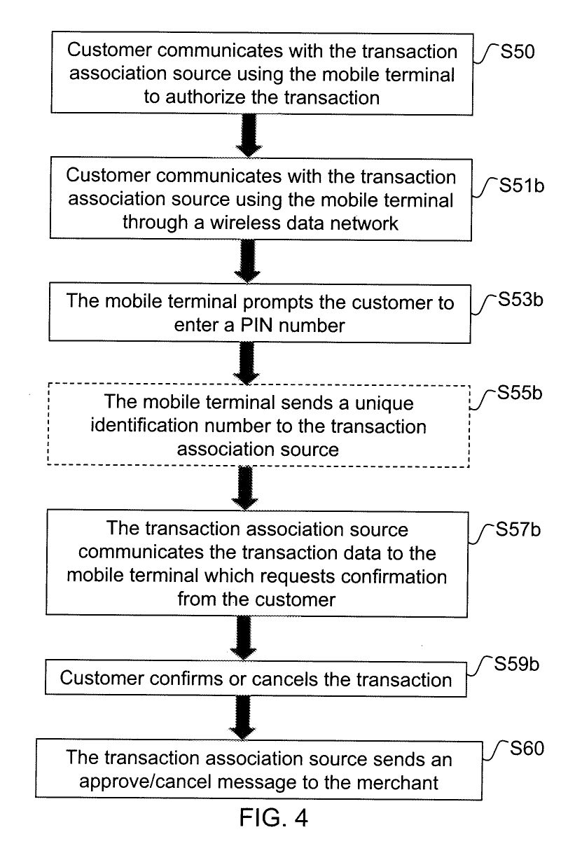

FIG. 4 is a flow chart providing further details on the communications between the customer and the transaction association source using the mobile terminal according to a second embodiment of the present invention. Referring to FIG. 4, the customer communicates with the transaction association source using a mobile terminal with wireless data connectivity through a wireless data network S51b. According to an embodiment of the present invention, the mobile terminal is equipped with processing means (e.g., microprocessor or microcontroller) and memory to execute a software program in order to establish a data communication with the transaction association source, transmit data (e.g., PIN number) to the transaction association source, receive data (e.g., payment transaction details such as price, goods/service description) from the transaction association source, generate a display of information related to the payment transaction on a display of the mobile terminal, guide and accept inputs (e.g., prompting for the PIN and/or the association code, confirm or decline a transaction) from the customer, and other suitable functions related to the payment transaction.

The software program may be preinstalled in the mobile terminal or may be downloaded and installed by a user of the mobile terminal. In an embodiment of the present invention, the software program is a Java-based software, and the mobile terminal is suitably equipped to execute the Java-based software. However, the present invention is not limited thereto, and the software program can be programmed in other suitable computer languages such as, but not limited to, C, C++, JavaScript, BASIC, assembly languages, etc.

Once the software program executing on the mobile terminal establishes data communication with the transaction association source, the mobile terminal prompts the customer to enter the PIN number, followed by the association code S53b. The customer may be pre-assigned with a unique PIN number that is used to identify and/or authenticate the customer. The PIN number may also be used to associate the customer's account with the transaction association source to the payment transaction. Furthermore, in some embodiments of the present invention, the mobile terminal may optionally send a unique identification number for identifying the mobile terminal S55b, together with the PIN number, to enhance the security of the payment transaction. In some embodiments of the present invention, the unique identification number may be the MAC address of the mobile terminal, an IP address assigned to the mobile terminal, a unique number stored in the mobile terminal, or other suitable unique number that can identify the mobile terminal. In some embodiments, the unique identification number may replace the PIN number to simplify the transaction, thereby removing the need for the customer to enter the PIN number manually.

After the transaction association source receives the data from the mobile terminal, the customer is authenticated with the data received. The transaction association source also sends or communicates the transaction data (e.g., description of the goods/services purchased and price) of the payment transaction to the mobile terminal which is configured to display the data to the customer and request confirmation from the customer S57b. After reviewing the data of the transaction, the customer may confirm or cancel the transaction S59b by speaking “YES” or “NO” or by pressing a “YES” button or an “NO” button on the mobile terminal. The “YES” and “NO” buttons may be dedicated keys assigned for confirmation function, or the buttons can be any keys that also serve other functions. For example, the “YES” key may be the “1” key on a keypad of the mobile terminal, and the “NO” key may be the “2” key on the mobile terminal. After the customer presses a key of the mobile terminal to confirm or cancel the payment transaction, the mobile terminal is configured to send corresponding data to the transaction association source to indicate the customer's selection.

Once the transaction association source receives a confirm/cancel response from the customer, the transaction association source sends a message to the merchant's transaction terminal to complete or cancel the payment transaction S60. If the customer confirms the payment transaction, the transaction association source sends an approve message to the merchant's transaction terminal to complete the transaction S70. In some embodiments, the transaction terminal may be configured to print out a customer receipt and/or a merchant's copy. If the customer cancels the payment transaction, the transaction association source sends a cancel message to the transaction terminal to terminate the transaction.

The embodiments of the present invention described above provide an improved mobile payment method and a system using the same. For example, the customer does not need to carry a credit card, therefore, there is no risk of losing the credit card or credit card fraud. Furthermore, the customer provides no personal information to the merchant during the payment transaction, therefore, the risk of losing personal private information may be avoided. In addition, the embodiments of the present invention may be implemented on older mobile phones that do not support data communication.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A system for authenticating a payment transaction comprising:
a transaction association source for providing an association code corresponding to a payment transaction;
a transaction terminal in communication with the transaction association source for initiating the payment transaction by requesting the association code from the transaction association source, the transaction terminal configured to receive the association code; and
a mobile terminal in communication with the transaction association source for transmitting the association code received by the transaction terminal to the transaction association source, and the mobile terminal for receiving data of the payment transaction from the transaction association source,
wherein the mobile terminal is configured to transmit a response message to the transaction association source to confirm or cancel the payment transaction, and the transaction association source is configured to transmit an approve or cancel message to the transaction terminal in response to receiving the response message.

2. The system of claim 1, wherein the transaction association source is configured to associate the payment transaction with a user of the mobile terminal.

3. The system of claim 2, wherein the transaction association source is in communication with an account of the user, a bank account of the user, a credit card account of the user, a debit account of the user, or a wireless service provider of the user.

4. The system of claim 1, wherein the transaction terminal comprises a point-of-sale terminal.

5. The system of claim 1, wherein the transaction terminal is configured to transmit the data of the payment transaction to the transaction association source prior to receiving the association code.

6. The system of claim 1, wherein the mobile terminal is configured to execute a software program to interact with a user of the mobile terminal and to communicate with the transaction association source by a wireless data network, and
the software program is configured to transmit the association code to the transaction association source by the wireless data network.

7. The system of claim 6, wherein the software program is configured to guide the user to input the association code to the mobile terminal, display the data of the payment transaction on a display unit of the mobile terminal, request the user to enter a confirmation input to confirm or deny the payment transaction, and transmit the response message to the transaction association source in response to the confirmation input.

8. The system of claim 6, wherein the software program is configured to authenticate the user of the mobile terminal by requesting the user to enter a passcode or password.

9. The system of claim 6, wherein the software program is configured to transmit a mobile terminal identification to identify the mobile terminal to the transaction association source.

10. The system of claim 9, wherein the mobile terminal identification comprises a caller ID information, a serial number of the mobile terminal, an IP address of the mobile terminal, a MAC address of the mobile terminal, or an identification number.

11. The system of claim 1, wherein the mobile terminal is configured to establish a voice communication channel to communicate with the transaction association source, and
the association code is transmitted to the transaction association source through the voice communication channel.

12. The system of claim 11, wherein the transaction association source comprises an interactive voice response (IVR) system for verbal communication with a user of the mobile terminal through the voice communication channel,
wherein the IVR system guides the user to verbally communicate the association code to the IVR system,
the IVR system verbally communicates the data of the payment transaction to the user, and
the IVR system verbally requests the user to enter a confirmation input to confirm or deny the payment transaction.

13. The system of claim 12, wherein the IVR system is configured to authenticate the user of the mobile terminal by requesting the user to enter a passcode or password.

14. The system of claim 13, wherein the user enters the passcode or password by an input device of the mobile terminal.

15. The system of claim 13, wherein the user enters the passcode or password by verbally dictating the passcode or password to the mobile terminal.

16. The system of claim 1, wherein the association code has a variable code length.

17. The system of claim 16, wherein the variable code length is varied in accordance with a number of payment transactions handled by the transaction association source during a time interval.

18. A method for authenticating a payment transaction, the method comprising:
initiating a payment transaction at a transaction terminal by requesting an association code corresponding to the payment transaction from a transaction association source in communication with the transaction terminal;
providing the association code received at the transaction terminal to a user of a mobile terminal;
transmitting the association code from the mobile terminal to the transaction association source in communication with the mobile terminal;
receiving data of the payment transaction from the transaction association source at the mobile terminal;
confirming or denying the payment transaction by transmitting a response message from the mobile terminal to the transaction association source; and
transmitting an approve or cancel message from the transaction association source to the transaction terminal in response to receiving the response message by the transaction association source.

19. The method of claim 18, wherein the transaction association source associates the payment transaction with the user of the mobile terminal.

20. The method of claim 19, wherein the transaction association source is in communication with an account of the user, a bank account of the user, a credit card account of the user, a debit account of the user, or a wireless service provider of the user.

21. The method of claim 18, wherein the transaction terminal comprises a point-of-sale terminal.

22. The method of claim 18, wherein the transaction terminal transmits the data of the payment transaction to the transaction association source prior to receiving the association code.

23. The method of claim 18, wherein the mobile terminal executes a software program to interact with the user of the mobile terminal and communicates with the transaction association source through a wireless data network, and
the software program transmits the association code to the transaction association source through the wireless data network.

24. The method of claim 23, wherein the software program guides the user to input the association code to the mobile terminal, displays the data of the payment transaction on a display unit of the mobile terminal, requests the user to enter a confirmation input to confirm or deny the payment transaction, and transmits the response message to the transaction association source in response to the confirmation input.

25. The method of claim 23, wherein the software program authenticates the user of the mobile terminal by requesting the user to enter a passcode or password.

26. The method of claim 23, wherein the software program transmits a mobile terminal identification to identify the mobile terminal to the transaction association source.

27. The method of claim 26, wherein the mobile terminal identification comprises a caller ID information, a serial number of the mobile terminal, an IP address of the mobile terminal, a MAC address of the mobile terminal, or an identification number.

28. The method of claim 18, further comprising establishing a voice communication channel between the mobile terminal and the transaction association source, and
transmitting the association code to the transaction association source through the voice communication channel.

29. The method of claim 28, wherein the transaction association source comprises an interactive voice response (IVR) system for verbal communication with the user of the mobile terminal through the voice communication channel,
wherein the IVR system guides the user to verbally communicate the association code to the IVR system,
the IVR system verbally communicates the data of the payment transaction to the user, and
the IVR system verbally requests the user to enter a confirmation input to confirm or deny the payment transaction.

30. The method of claim 29, wherein the IVR system authenticates the user of the mobile terminal by requesting the user to enter a passcode or password.

31. The method of claim 30, wherein the user enters the passcode or password by an input device of the mobile terminal.

32. The method of claim 30, wherein the user enters the passcode or password by verbally dictating the passcode or password to the mobile terminal.

33. The method of claim 18, wherein the association code has a variable code length.

34. The method of claim 33, wherein the variable code length is varied in accordance with a number of payment transactions handled by the transaction association source during a time interval.
